(19) United States
(12) Patent Application Publication
(10) Pub. No.: US 2023/0008321 A1
(43) Pub. Date: Jan. 12, 2023

(54) Fabric and bedding Product used in bedding

(71) Applicant: Dellon Dai Chen, Hangzhou (CN)

(72) Inventor: Dellon Dai Chen, Hangzhou (CN)

(21) Appl. No.: 17/389,370

(22) Filed: Jul. 30, 2021

(30) Foreign Application Priority Data
Jul. 12, 2021 (CN) 202121580503.2

(51) Int. Cl. A47G 9/02; B32B 3/12; B32B 27/12; B32B 7/12

(52) U.S. Cl. CPC A47G 9/0238; B32B 3/12; B32B 27/12; B32B 7/12; B32B 2250/02; B32B 2274/00; B32B 2307/732; B32B 2307/51; B32B 2601/00

(57) ABSTRACT

A fabric for bedding, comprising a fabric body, the fabric body is glued to an elastic surface layer, and the elastic surface layer is molded with a three-dimensional pattern.

### TECHNOLOGY

The invention relates to the technical field of daily necessities, in particular to a fabric and bedding for bedding.

### BACKGROUND TECHNOLOGY

Ordinary bedding sets (such as pillowcases, pillowcases and mattress covers, etc.) only play a role in protecting the cleaning and aesthetics of bedding. However, it can not make the user have a certain coolness and constant temperature effect and buffer the pressure of the contact area of the human body, so as not to improve the user's comfort and sleep quality.

Chinese patent literature (announcement date: Jan. 5, 2018, bulletin number: CN 206840856U) disclosed a cool breathable fabric and bedding, involving the field of daily necessities. The cool breathable fabric comprises at least one layer of material structure unit, each layer of structure unit includes cool fiber fabric layer, breathable layer and connecting cool fiber fabric layer and breathable layer bonding layer, breathable layer with multiple first breathable holes, breathability performance is good, effective cooling, cool and comfortable. A bedding, bedding on the outer surface of the surface laid with the cool breathable fabric, its comfortable cool, easy to clean. Although the above-mentioned technical scheme can achieve the function of cool breathability, but its complex structure, making the manufacturing cost is high.

### Invention Content

The purpose of the invention is to solve the existing bedding fabric can not improve the user's comfort and sleep quality problems, but to provide a certain coolness and constant temperature, can buffer the pressure of the human contact area, thereby improving the user's comfort and sleep quality for bedding fabrics and bedding, the fabric and bedding structure is simple, low cost, and environmental protection, conducive to human health, conducive to widespread use.

The technical scheme used by the invention to achieve the purpose of its invention is: a fabric for bedding, including the fabric body, the fabric body is bonded with an elastic surface layer, the elastic surface layer is molded with a three-dimensional pattern. The fabric used for bedding, by bonding a layer of elastic surface on the fabric body, and the elastic surface layer through the mold to form a number of three-dimensional pattern, the fabric in use, due to the setting of a three-dimensional pattern, can effectively buffer the pressure of the contact part of the human body, thereby improving the user's comfort and sleep quality. And the fabric used for bedding, simple structure, low manufacturing costs, can be washed, easy to clean and reuse, environmental protection, more conducive to human health.

As a preferred, the elastic surface layer is bonded to the upper or/and lower surface of the fabric body. The elastic surface layer can be glued to either or both surfaces of the fabric, forming a two-layer structure or a three-layer structure, set as needed.

As a preferred, the three-dimensional pattern is a bumpy three-dimensional structure formed with an elastic surface layer. The three-dimensional pattern of the embossed surface layer is molded into a bumpy three-dimensional structure, which can effectively buffer the pressure of the contact part of the human body, while the three-dimensional pattern can be a circular, hexagonal, trihedrome, teeters, octagonal and other structures, or it can be designed according to specific needs of flower patterns. As long as it is able to form a three-dimensional pattern through die-molding, can be all-in-one die to the elastic surface layer.

As a preferred, the thickness of the three-dimensional pattern is 2 mm to 80 mm. The thickness of the three-dimensional pattern, that is, the height of the three-dimensional pattern bump, can be preferably in 2 mm to 80 mm. Of course, thicknesses less than 2 mm or greater than 80 mm can also be used.

As a preferred, the elastic surface layer is a thermoplastic elastic decent layer. Elastic surface layer preferably thermoplastic elastic decent layer, that is, TPE (Thermoplastic Elastic thermoplastic elastomer) surface layer, TPE material has a certain coolness and constant temperature of the role and good elasticity, added TPE three-dimensional pattern molded bedding cloth has a certain coolness and constant temperature, and buffer the role of human contact pressure, can make users improve comfort and sleep quality. TPE material stereo pattern molded bedding cloth can also be washed, easy to clean and reuse.

The technical scheme used by the invention to achieve its second invention purpose is: a bedding, which is characterized by: including the main body of the article made of the fabric used for bedding. The main body of the bedding supplies is made of fabrics used for bedding, that is, in the main use of the fabric with elastic surface layer, other parts can be used in conventional fabrics, bedding as a whole with elastic surface fabrics.

As a preferred, the main body of the supplies for bed linen, bedspread, mattress cover, pillowcase or pillowcase. The main body of the supplies can be any kind of bedding, can be made with elastic surface fabric.

The beneficial effect of the invention is: the fabric used for bedding, by bonding a layer of elastic surface on the fabric body, and the elastic surface layer through the mold formation of a number of three-dimensional patterns, the TPE (Thermoplastic Elastic thermoplastic elastomer) material with a different three-dimensional pattern to press the mold method glued to the fabric of bedding outside or inside, TPE material has a certain cool and constant temperature effect and good elasticity, TPE three-dimensional pattern molded bedding has a certain cool feeling and constant temperature effect, can effectively buffer the body contact pressure, can enable users to improve comfort and sleep quality, but also wash, easy to clean and reuse, more environmentally friendly, more conducive to human health.

### ILLUSTRATED INSTRUCTIONS

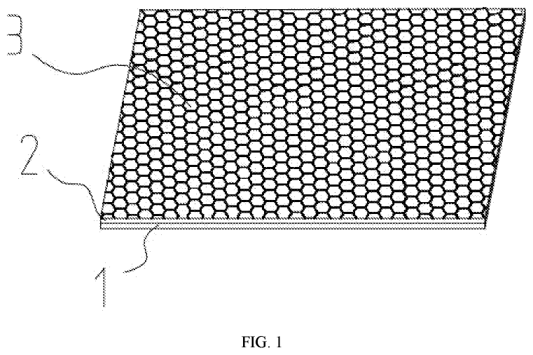

FIG. 1 is a structural diagram of the fabric used in bedding by the invention;

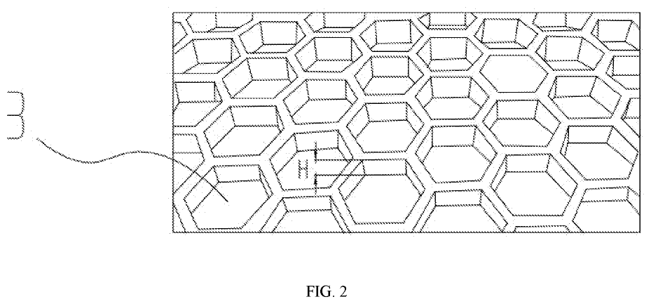

FIG. 2 is a structural diagram of the three-dimensional pattern in the invention;

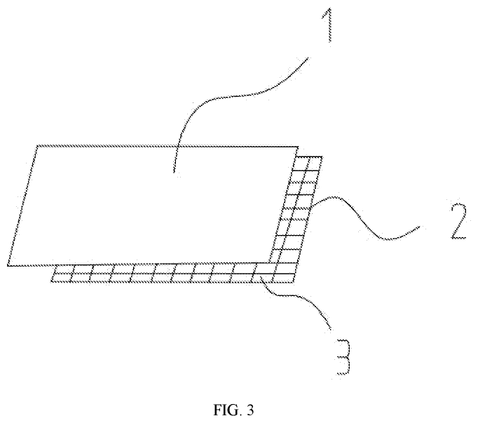

FIG. 3 is a structural diagram of the fabric used in bedding by the invention;

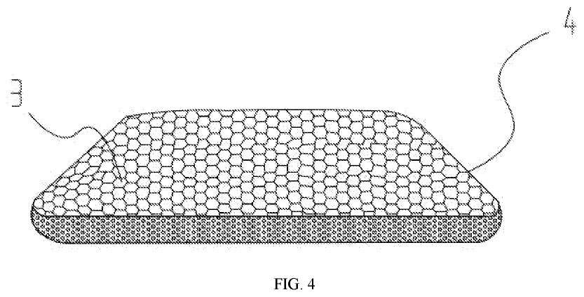

FIG. 4 is a structural diagram of the main body of the invention supplies;

Figure: 1, fabric body, 2, elastic surface layer, 3, three-dimensional pattern, 4, the main body of supplies.

### HOW TO IMPLEMENT IT

The following through the specific embodiments and combined with the drawings of the technical scheme of the invention for further detailed explanation.

### The Embodiment 1

In the embodiments shown in FIG. 1, FIG. 2 and FIG. 3, a fabric for bedding, including fabric body 1, the fabric body 1 is glued to an elastic surface layer 2, and the elastic surface layer 2 is molded with a three-dimensional pattern 3. The elastic surface layer 2 is a thermoplastic elastic decent layer. Elastic surface layer 2 for thermoplastic elastic decent layer, that is, TPE (Thermoplastic Elastic thermoplastic elastomer) surface layer, TPE material has a certain coolness and constant temperature of the role and good elasticity, added TPE three-dimensional pattern molded bedding cloth has a certain coolness and constant temperature, and buffer the role of human contact pressure, can make users improve comfort and sleep quality. TPE material stereo pattern molded bedding cloth can also be washed, easy to clean and reuse. Fabric body 1 is a conventional fabric, can be cotton, fiber, weaving, linen, chemical fiber, blending, Modale and other common conventional fabrics, the embodiment of this embodiment is cotton.

The elastic surface layer 2 is bonded to the upper or/and lower surface of the fabric body 1. Elastic surface layer 1 can be glued to any surface of the fabric or both surfaces, forming a two-layer structure or three-layer structure, specifically set as needed.

The three-dimensional pattern 3 is a bumpy three-dimensional structure formed with an elastic surface layer 2. Elastic surface layer 2 on the one-piece molded into a bumpy three-dimensional structure of the three-dimensional pattern 3, so as to effectively buffer the pressure of the human contact part, and three-dimensional pattern 3 can be round, hexagonal, trihedrome, teeters, octagonal and other structures, can also be designed according to specific needs of flower type. As long as it is able to form a three-dimensional pattern through die-molding, can be all-in-one die to the elastic surface layer. In this embodiment, the stereo pattern 3 is the whole honeycomb pattern formed by the structure of a hexagonal body. The thickness of the three-dimensional pattern H is 2 mm to 80 mm. The thickness of the three-dimensional pattern, that is, the height of the three-dimensional pattern bump, can be preferably in 2 mm to 80 mm. Of course, thicknesses less than 2 mm or greater than 80 mm can also be used.

As shown in FIG. 4, a bedding, including the fabric used for bedding made of the main body of the supplies 4. The bedding body 4 is made of fabric for bedding, that is, in the main use of the use of fabric with elastic surface layer, other parts can be used in conventional fabrics, bedding as a whole with elastic surface fabric.

The main body of the supplies described is sheets, bedspreads, mattress covers, pillowcases or pillowcases. The main body of the supplies can be any kind of bedding, can be made with elastic surface fabric. The main body of bedding in this embodiment is the mattress cover. The bedding can also be with skirt sheets, skirt can use conventional fabrics, can also be with three-dimensional mattress cover, pillowcase, pillowcase and so on. Of course, it also includes pillows for bed, pillows, etc.

The fabric used for bedding, by bonding a layer of elastic surface on the fabric body, and the elastic surface layer by molding to form a number of three-dimensional patterns, the TPE (Thermoplastic Elastic thermoplastic elastomer) material with different three-dimensional pattern to mold the method glued to the bedding fabric outside or inside, TPE material has a certain coolness and constant temperature of the role and good elasticity, TPE three-dimensional pattern molded bedding has a certain cool feeling and constant temperature effect, can effectively buffer the body contact pressure, can enable users to improve comfort and sleep quality, but also wash, easy to clean and reuse, more environmentally friendly, more conducive to human health.

The above embodiments are only some of the embodiments of the invention, not all of them. At the same time, based on the embodiments described in the invention, all other embodiments obtained by ordinary technical personnel in this field on the basis of the technical scheme applied for without creative work shall fall within the scope of the protection of the invention.

1. A fabric for bedding, comprising a fabric body (1), which is characterized by: the fabric body (1) is glued to an elastic surface layer (2), and the elastic surface layer (2) is molded with a three-dimensional pattern (3).

2. A fabric for bedding of claim 1, wherein the elastic surface layer (2) is glued to the upper or/and lower surface of the fabric body (1).

3. A fabric for bedding of claim 1 or 2, wherein the three-dimensional pattern (3) is a bumpy three-dimensional structure formed in a die-molded form with an elastic surface layer (2).

4. A cloth for bedding, wherein the thickness of the three-dimensional pattern (3) of 2 mm to 80 mm.

5. A fabric for bedding of claim 1 or 2, wherein the elastic surface layer (2) being a thermoplastic elastic decent layer.

6. A bedding, comprising the main body of the article (4) comprising fabrics used for bedding.

7. A bedding of claim 6, wherein the fact that the subject of the supplies (4) is a bed sheet, bedspread, mattress cover, pillowcase or pillowcase.
